(19) United States
(12) Patent Application Publication
(10) Pub. No.: US 2022/0394039 A1
(43) Pub. Date: Dec. 8, 2022

(54) SEAMLESSLY SECURING ACCESS TO APPLICATION PROGRAMMING INTERFACE GATEWAYS

(71) Applicant: VMWARE, INC., Palo Alto, CA (US)

(72) Inventors: Rajshekhar Deodurg, Bangalore (IN); Dinah Cj, Bangalore (IN)

(21) Appl. No.: 17/394,442

(22) Filed: Aug. 5, 2021

(30) Foreign Application Priority Data
Jun. 3, 2021 (IN) 202141024813

(51) Int. Cl. H04L 29/06; H04L 9/32; G06F 9/54; G06F 21/44; H04L 9/30

(52) U.S. Cl. CPC H04L 63/102; H04L 9/3234; G06F 9/541; G06F 21/44; H04L 9/30; H04L 9/3236; G06F 2221/2137

(57) ABSTRACT

Seamlessly securing access to application programming interface gateways includes receiving a request from a client for a token using which the client can make a call to an API. The request includes a client identifier identifying the client. In response to receiving the request, a call is made to the API for the token, and the token, including application credentials, are received from the API. In response to receiving the token, the token is encoded to include the encrypted client identifier and the encrypted application credentials. The encoded token is transmitted to the client.

### RELATED APPLICATION

Benefit is claimed under 35 U.S.C. 119(a)-(d) to Foreign Application Serial No. 202141024813 filed in India entitled “SEAMLESSLY SECURING ACCESS TO APPLICATION PROGRAMMING INTERFACE GATEWAYS”, on Jun. 3, 2021, by VMware, Inc., which is herein incorporated in its entirety by reference for all purposes.

### TECHNICAL FIELD

This application relates to computer-implemented methods, computer software and computer systems for accessing application programming interfaces (APIs).

### BACKGROUND

Micro-services technology facilitates digital transformation in the field of application development. Almost every resource or functionality is exposed as an API. With the increase in the number of APIs, data transfer is implemented via layer 7 HTTP(s) protocol. Because data transfer comes with the risk of data exploitation or hacking leading to data breaches, securing APIs is important.

Tokens can be used to authenticate requests received at APIs to gain access to electronically restricted resources. Tokens are useable as an alternative or in addition to passwords, and are verifiable to determine whether to provide or otherwise allow access or to perform operations. An access token provided to the user can authenticate the user as being authorized to access a resource. When the user wants to access the resource, the user can provide the access token, which can be validated. Such an authorization token can be generated, for example, by an authorization server that exchanges authorization codes to verify authenticity of the requestor.

### SUMMARY

This specification describes technologies relating to seamlessly securing access to API gateways.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of an example computer system architecture to manage access requests.

FIG. 2 is a flowchart of an example of a process to generate a token for a client.

FIG. 3 is a flowchart of an example of a process to validate a token for a client.

FIG. 4 is flowchart of an example of a process to encrypt and provide an encrypted token to a client.

FIG. 5 is a block diagram of an example of a processing platform.

Like reference numbers and designations in the various drawings indicate like elements.

### DETAILED DESCRIPTION

An API gateway is an API management tool that resides between a client and a collection of backend services. The API gateway can act as a reverse proxy to accept API calls, aggregate various services required to fulfill the calls, and return the appropriate result. Most enterprise APIs are deployed via API gateways that handle tasks used across a system of API services including, for example, user authentication, rate limiting and statistics. The ability of APIs to reduce complexity and overhead of deployment, scalability and maintenance makes APIs useful in micro-services architecture. In a sense, APIs connect all micro-services together.

API security is the protection of the integrity of APIs. An API can be secured in many ways, one of which is implementing OAuth 2.0, an industry-standard authorization protocol or framework that enable applications to obtain limited access to user accounts on an HTTP service. OAuth 2.0 works by delegating user authentication to the service that hosts the user account, and authorizing third-party applications to access the user account. OAuth 2.0 defines four roles—resource owner, client, resource server and authorization server. The resource owner is the user who authorizes an application to access their account. The user can limit the scope of the access, e.g., read or write access. The application's authorization is limited to the scope granted by the user. The resource server hosts the protected user accounts, and the authorization server verifies the identity of the user, and then issues access tokens to the application. The client is the application that wants to access the user's account and must be authorized, by the user, to do so. Also, the user's authorization must be validated by the API before the application can gain access to the user's account.

A micro-services architecture implementing OAuth2.0 authorization protocol deals with multiple APIs, each of which, in turn, requires the handling of multiple tokens provided by different API providers. APIs to applications implemented by the micro-services architecture can be secured by implementing a single-entry point API gateway to the architecture. Given that the single entry point grants access to multiple APIs, the API gateway needs to be secure, robust and agile. When OAuth2.0 or other authorization protocol which involves multiple tokens is implemented in such an architecture, clients may be burdened to handle all the tokens.

For example, when a customer desires to retrieve details from an application, the customer has to first provide their CustomerID. To do so, the customer must first obtain the CustomerID from the authorization server (e.g., Oracle Access Manager) using either the customer credentials or an OAM SessionID. Then, the customer must procure an access token to the API gateway to the application. To do so, the customer must provide a ClientID and a ClientSecret. The customer has to embed the CustomerID and the API gateway's access token into an actual request of retrieving the details. In another example, when a partner desires to create an opportunity or a case in a distributed computing and social venture software-as-a-service (SaaS) (e.g., Salesforce Dot Com), the partner has to first obtain a session token from SFDC, and then procure an access token for the API gateway by providing the ClientID and the ClientSecret. The partner has to embed both these tokens into the actual request of creating an opportunity or a case. The workflow in each of these examples necessitates invocation of two transactions prior to the actual API call, which can be tedious and cause unnecessary consumption of bandwidth. In addition, the customer/partner carries the burden of handling sensitive information and using such information in subsequent invocations.

This disclosure describes techniques to reduce the burden mentioned above using the features of a claim set in a token, e.g., JSON Web Token (JWT), which are an open, industry standard RFC 7519 method for representing claims securely between two parties, and a custom plug-in for the API gateway. In the context of a JWT, claims are pieces of information asserted about a subject. For example, an ID token can contain a claim called “name” that asserts that the name of the user authenticating is a particular name. In a JWT, a claim appears as a name/value pair where the name is always a string and the value can be any JSON value. A claim, in the context of the JWT, refers to a name (or key). A token, such as JWT, has a structure which includes three parts: a header, a payload and a signature. For example, a JWT has the following format: Header.Payload.Signature. The header can include information for the type of the code and the signing algorithm being used. The payload of the authorization code can include claims that include statements about an entity (e.g., the client device 102) and additional data. To create the signature part of the code, the architecture 104 can combine data including the encoded header, the encoded payload, and an identification of the algorithm to be specified in the header, with the architecture 104 then signing that combination of data.

By implementing the techniques described here, the customer who desires to retrieve details from an application obtains an access token from the access token endpoint by providing the ClientID, ClientSecret and the authorization server credentials. The customer uses this access token while invoking the API exposed via the API gateway to retrieve required details. When the API gateway receives the request for retrieval of details, the API gateway unsigns the token to obtain the claimset added as part of the token. If the claimset includes the encrypted CustomerID, then the API gateway forwards the request to the authorization micro-service to decrypt the CustomerID. The CustomerID is added to the original request that was received by the gateway and then sent to the downstream application.

All customer tokens have internal calls to the authorization server to obtain the CustomerID. The client remains unaware of such internal calls because the information is not sent back to the client, thereby remaining within the internal network, unless the downstream application is outside the network. The client/caller needs to handle only API gateway token and is relieved from handling all other varied tokens and sensitive information provided by various validation endpoints. Consequently, implementing the techniques described here achieves the usage of a single token, e.g., a single JWT, for all kinds of authorization mechanisms dealt in the downstream application. API gateway's custom plug-in handles adding this information into the actual client request and sending the same to the downstream calls. Multiple rounds of requests and responses over the network and associated confusion are reduced, thereby reducing traffic congestion. The gateway plug-in along with the authorization protocol makes the experience seamless and hassle-free.

In addition, the techniques described here enable a partner to create an opportunity or case in a distributed computing and social venture software-as-a-service (SaaS) (e.g., Salesforce Dot Com (SFDC)) by obtaining an access token from the access token endpoint by providing the ClientID, ClientSecret and SFDC credentials. The partner can use this token while invoking the API exposed via the API gateway to create the opportunity or the case. When the API Gateway receives the request for creation of an opportunity or a case, the API Gateway first validates the access token by sending it to an authorization server (described later) and obtains the relevant SFDC sessionID and email ID. The authorization server adds the sessionID into the original request that was received by the API gateway and then sends it downstream to SFDC. SFDC validates the session ID and grants permission to execute the required operation, i.e., to create the opportunity. The client remains unaware of the internal calls to SFDC embedded in the partner tokens. This information is not sent back to the client and hence does not move out the internal network (unless the downstream is outside the network). The client/caller needs to handle only API Gateway token and is relieved from handling all other varied tokens and sensitive information provided by various validation backends. Implementing the techniques described here achieves the usage of a single JWT for all kinds of authorization mechanisms dealt in the downstream application. The custom plugin (described later) adds this information into the actual client request and is sent to the downstream calls.

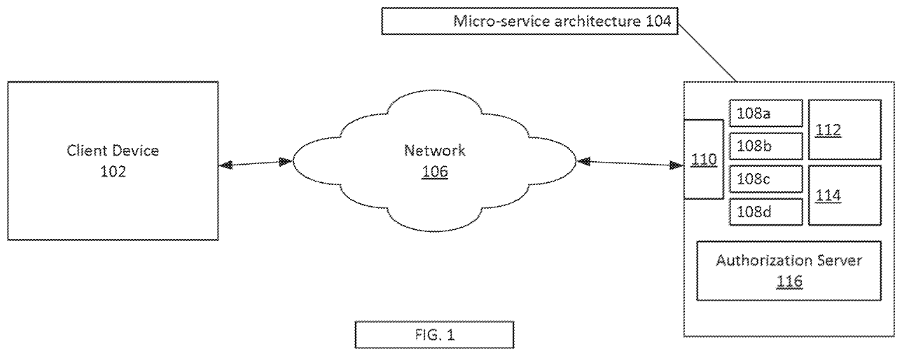

FIG. 1 is a schematic of an example computer system architecture to manage access requests. The architecture implements multiple client devices (e.g., client device 102) that accesses a micro-service architecture 104 over a network 106. The micro-service architecture 104 implements multiple applications (e.g., applications 108a, 108b, 108c, 108d) on respective virtual machines. Each application is accessible by a respective API and the architecture 104 itself is accessible by an API gateway 110. The micro-service architecture 104 can include a micro-service in memory cache 112 and a data store 114 (e.g., a database) whose functions are described below. In some implementations, the client device 102 can be any computing device, e.g., a desktop computer, a laptop computer, a handheld computer, a table computer, a personal digital assistant (PDA), a cellular telephone, a network appliance, a camera, a smart phone, an enhanced packet radio service (EGPRS) mobile phone, a media player, a navigation device, an email device, a game console or any combination of two or more of these or other data processing devices. The network 110 can include a large computer network, such as a local area network (LAN), a wide area network (WAN), the Internet, a cellular network, a telephone network (e.g., PSTN) or any combination of the networks connecting any number of communication devices, mobile computing devices, fixed computing devices and server systems.

In some implementations, the micro-services architecture 104 hosts an authorization server 116 to support execution of secure requests to access the client device 102 and applications implemented by the micro-service architecture 104. The authorization server 116 can be implemented as one or more computer systems that include one or more processors, for example, hardware processor or processors, and a computer-readable medium (e.g., a non-transitory computer-readable medium) storing computer instructions executable by the one or more processors to perform operations described here.

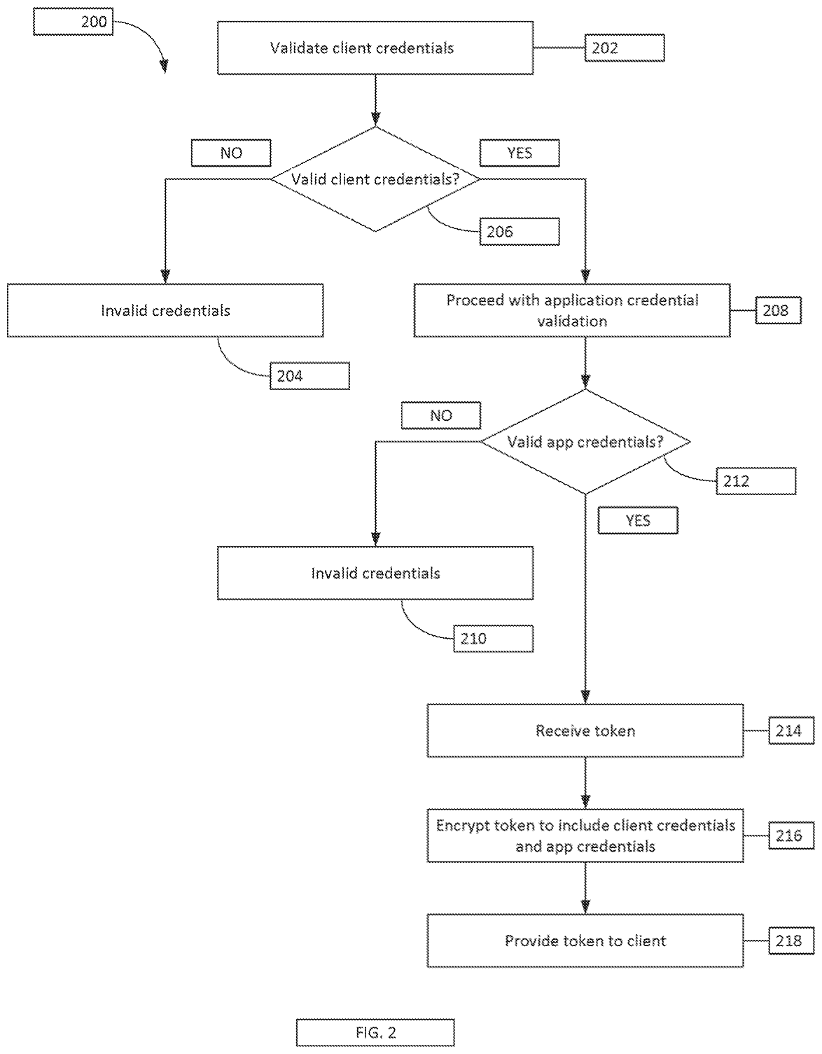

FIG. 2 is a flowchart of an example of a process 200 to generate a token for a client. All or some of the process steps of the process 200 can be implemented by one or more or all of the components of the micro-service architecture 104 including the API gateway 110 and the authorization server 116. Client device credentials, e.g., ClientID and secret used to validate and generate tokens, are stored in the in-memory cache 112. The credentials are loaded into the in-memory cache 112 from the data store 114 during boot up of the authorization server 116. At 202, the authorization server 116 validates client credentials including the ClientID and secret. All client secret stored in the data store 114 is hashed. Consequently, any credential validation implemented by the authorization server 116 includes hashing a received secret and implementing a string-to-string match with a stored, hashed secret. At 206, the authorization server 116 checks if the received credentials are valid. If the authorization server 116 determines that the credentials are invalid (e.g., because the string-to-string comparison does not result in a match with any stored, hashed secret), then, at 204, the authorization server 116 returns an error message indicating invalid client credentials. Alternatively, if the authorization server 116 determines that the received credentials are valid (e.g., because the string-to-string comparison results in a match with a stored, hashed secret), then, the authorization server 116 concludes that the client credentials are valid.

Once the authorization server 116 validates client credentials, at 208, the API gateway 110 proceeds to validate application credentials. To do so, the API gateway 110 makes a call to the application that the client device 102 is attempting to access. The client device 102 is unaware of the call that the API gateway 110 makes to the backend application. By implementing the techniques described here, the task of making the call to the backend application is transferred from the client device 102 to the API gateway 110.

The application has its own application credentials including ApplicationID and password, which the application provides to the API gateway 110 in response to the API gateway 110 call. At 212, the API gateway 110 checks if the application credentials are valid. If the API gateway 110 determines that the application credentials are invalid, then, at 210, the API gateway 110 returns an error message indicating invalid application credentials. Alternatively, if the API gateway 110 determines that the application credentials are valid, then, starting at 214, the API gateway 110 initiates the process steps to generate a token to provide to the client device 102.

At 214, after validating the app credentials, the API gateway 110 receives an application token from the application using which the client device 102 can make a call to the application through the API gateway 110. At 216, the API gateway 110 encrypts the received application token into an access token, e.g., as a JWT. In some implementations, the API gateway 110 encrypts the access token to include the client credentials and the application credentials. For the application token, the API gateway 110 generates the access token which is a signed JWT and is based on asymmetric Rivest-Shamir-Adleman (RSA) algorithm, which has a private key and a public key. Both keys are stored in the data store 114, and the API gateway 110 obtains the private key to encrypt the ClientID to include the CustomerID. The API gateway 100 additionally encrypts the client credentials into the access token. To do so, for example, the API gateway 100 implements the A128CBC_Hs256 encryption method. At 218, the API gateway 110 returns the encrypted access token, which includes both the client credentials and the application token to access the backend application, to the client device 110. The API gateway 110 implements a custom plug-in which is used while un-signing the encrypted access token as described below.

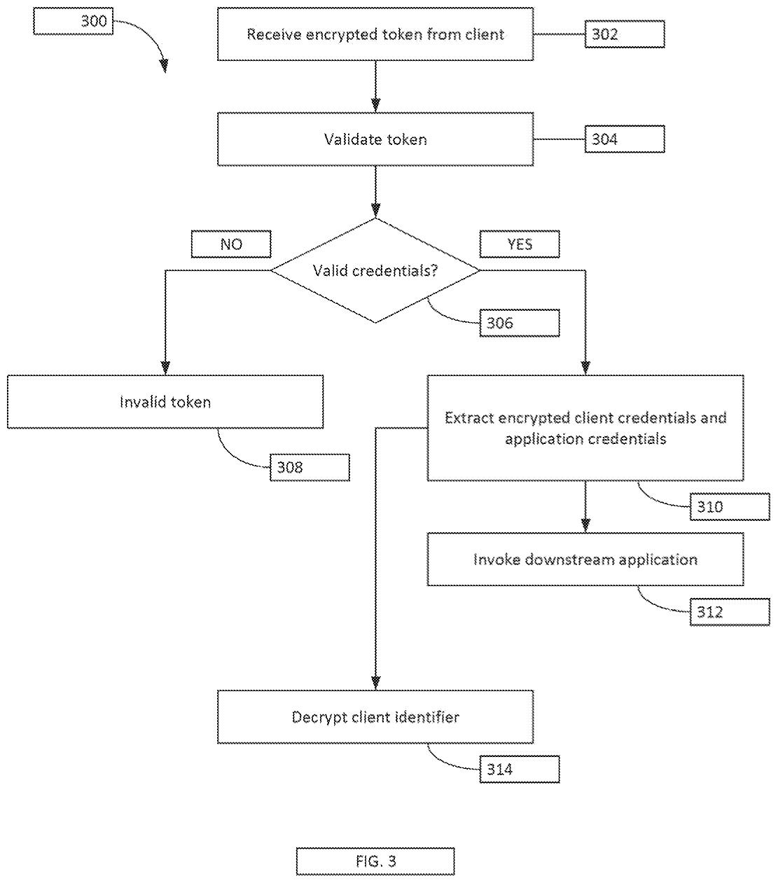

FIG. 3 is a flowchart of an example of a process 300 to validate a token for a client. All or some of the process steps of the process 300 can be implemented by one or more or all of the components of the micro-service architecture 104 including the API gateway 110 and the authorization server 116. At 302, the API gateway 110 receives the encrypted token from the client device 102. At 304, the API gateway 110 implements process steps to validate the token. In some implementations, as mentioned above, the API gateway 110 implements a custom plug-in used to decrypt the encrypted access token. To do so, the API gateway 110 uses the public key generated when the access token was encrypted. The encrypted access token includes a Time To Live (TTL), for example, of about 20-30 minutes. In addition to using the public key to decrypt the access token, the API gateway 110 also checks that the TTL has not expired.

At 306, the API gateway 110 checks if the credentials are valid. If the API gateway 110 determines that the credentials are not valid, then, at 308, the API gateway 110 returns an error message indicating invalid client credentials. If the API gateway 110 determines that the credentials are valid, then, at 310, the API gateway 110 extracts the encrypted client credentials. At 312, the API gateway 110 invokes the downstream application, for example, by including the application credentials in the customer header. At 314, the API gateway 110 decrypts the client credentials.

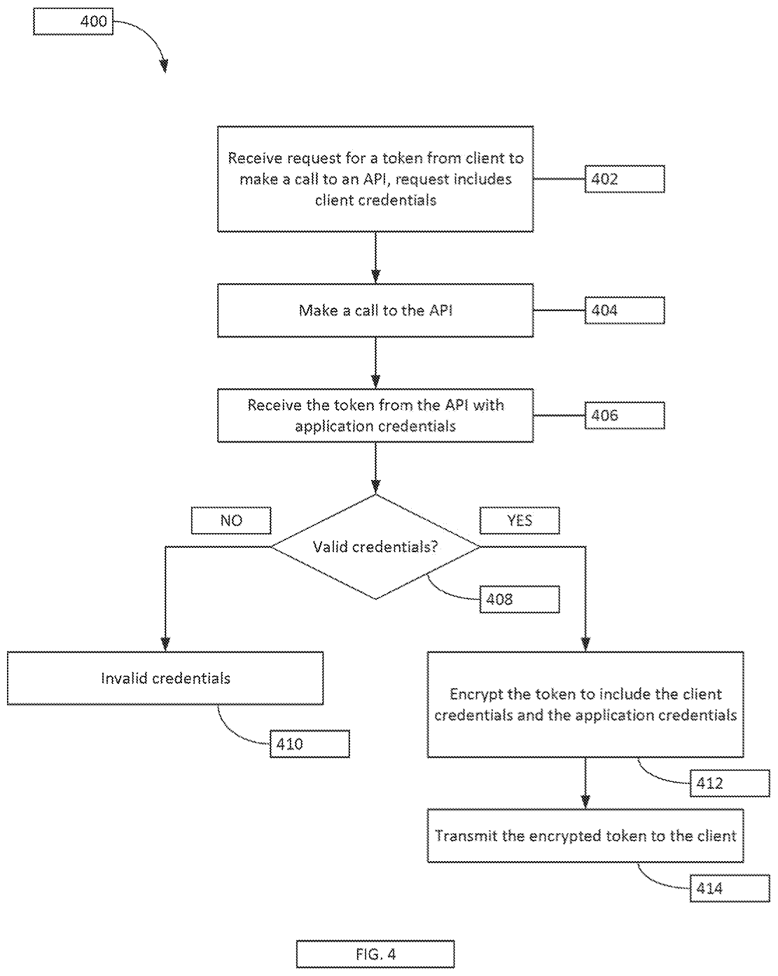

FIG. 4 is flowchart of an example of a process 400 to encrypt and provide an encrypted token to a client. All or some of the process steps of the process 300 can be implemented by one or more or all of the components of the micro-service architecture 104 including the API gateway 110 and the authorization server 116. At 402, the micro-service architecture 104 receives, from the client device 102, a request for a token so that the client device 102 can make a call to an API. The request includes client credentials identifying the client. In response to receiving the request, at 404, the micro-service architecture 104 makes a call for the token to an application backend. In response, at 406, the micro-service architecture 104 receives the token including application credentials. Upon receiving the token, at 408, the micro-service architecture 104 checks if the credentials are valid. If the micro-service architecture 104 determines that the credentials are invalid, then, at 410, the micro-service architecture 104 returns an error message indicating that the credentials are invalid. If the micro-service architecture 104 determines that the credentials are valid, then, at 412, the micro-service architecture 104 encrypts the token to include at least a portion or all of the client credentials and at least a portion or all of the application credentials. At 412, the micro-service architecture 104 transmits the encrypted token to the client.

The client (i.e., the client device 102) uses the encrypted token to make a call to the application via the API gateway 110 of the micro-service architecture 104. In such instances, the micro-service architecture 104 receives, from the client device 102, the encrypted token. In response to receiving the encrypted token, the micro-service architecture 104 determines that the encrypted token is valid. Upon determining that the encrypted token is valid, the micro-service architecture 104 decrypts the encrypted token to identify the client credentials and the application credentials. Subsequently, the micro-service architecture 104 initiates a session with the API of the application identified by the application credentials and to which the client device makes a call. To initiate the session, the micro-service architecture 104 transmits the application credentials to the application. The encrypted token is associated with an expiration time. To determine that the encrypted token is valid, the micro-service architecture 104 determines that the expiration time has not elapsed. To encrypt the token to include the client credentials and the application credentials, the micro-service architecture 104 generates a public key and a private key associated with the token. To decrypt the encrypted token, the micro-service architecture 104 utilizes the public key and the private key. In response to determining that the request for the token is a validated request, the micro-service architecture 104 makes a call to the API for the token without informing the client. To receive the request for the token, the micro-service architecture 104 determines that the client credentials are valid. To determine that the client credentials are valid, the micro-service architecture 104 matches a hash value of the client credentials included in the request with a stored hash value of valid client credentials.

In sum, implementing the subject matter described here provides a mechanism to seamlessly handle sensitive information acquired from different applications. The mechanism helps in reduction of traffic congestion and network bandwidth. The mechanism uses asymmetric RSA algorithm and A128CBC_HS256 to keep sensitive information secure. The information is embedded into the access token, thus avoiding the need of a persistent data store. The techniques described here can be implemented to allow a client device to securely access any backend whose information would be sensitive.

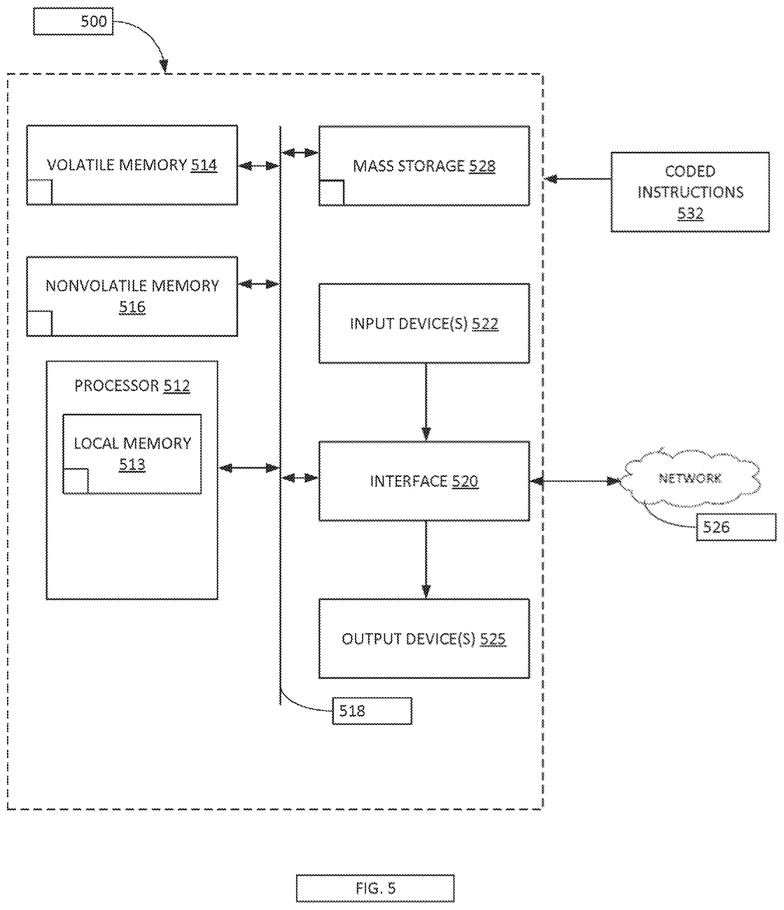

FIG. 5 is a block diagram of an example of a processing platform 500 configured to execute the techniques described in this disclosure, specifically, the methods described above with reference to FIGS. 1-3. The processor platform 500 can be, for example, a server, a personal computer, a workstation, a self-learning machine (e.g., a neural network), a mobile device (e.g., a cell phone, a smart phone, a tablet computer), a personal digital assistant (PDA), an Internet appliance, or any other type of computing device. In some implementations, the processor 512 implements the process steps shown in FIGS. 1-3.

The processor platform 500 includes a processor 512, which is hardware. For example, the processor 512 can be implemented by one or more integrated circuits, logic circuits, microprocessors, graphics processing units (GPUs), digital signal processors (DSPs), or controllers. The hardware processor 512 can be a semiconductor, e.g., silicon, based device. The hardware processor 512 can implement the components of systems that implement the process steps described with reference to FIGS. 1-3.

The processor 512 includes a local memory 313 (e.g., a cache). The processor 512 is in communication with a main memory including a volatile memory 514 and a non-volatile memory 516 via a bus 518. The volatile memory 514 can be implemented by synchronous dynamic random access memory (SDRAM), dynamic random access memory (DRAM) or other type of random access memory device. The non-volatile memory 516 can be implemented by flash memory and/or any other desired type of memory device. A memory controller controls access to the main memory 514, 516.

The process platform 500 also includes an interface circuit 520 implemented by any type of interface standard, for example, an Ethernet interface, a universal serial bus (USB), a wired or wireless interface, a near field communication (NFC) interface and/or a PCI express interface. One or more input devices 522 are connected to the interface circuit 520. The input devices permit a user to enter data and/or commands to the processor 512. The input devices can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520. The output devices 524 can be implemented, for example, by display devices, e.g., light emitting diode (LED), an organic LED (OLED), a liquid crystal display (LCD), a cathode ray tube display (CRT), an in-place switching (IPS) display, a touchscreen, etc. and/or a tactile output device, a printer and/or speaker. The interface circuit 520 typically includes a graphics driver card, a graphics driver chip and/or a graphics driver processor.

The interface circuit 520 also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 also includes one or more mass storage devices 528 for storing software and/or data. Examples of such mass storage devices 528 include floppy disk drives, hard disk drives, compact disk drives, redundant array of independent disks (RAID) systems, digital versatile disk (DVD) drives, or combinations of them.

Machine executable instructions 532 represented by any one or more of the flowcharts of FIGS. 1-3 can be stored in the mass storage device 528, in the volatile memory 514, in the non-volatile memory 516, and/or on a removable non-transitory computer readable storage medium such as a CD or DIV.

Certain aspects of the subject matter described here can be implemented as a method. A request is received from a client for a token using which the client can make a call to an API. The request includes a client identifier identifying the client. In response to receiving the request, a call is made to the API for the token, and the token, including application credentials, are received from the API. In response to receiving the token, the client identifier is encrypted. The token is encoded to include the encrypted client identifier and the application credentials. The encoded token is transmitted to the client.

An aspect combinable with any other aspect includes the following features. The encoded token is received from the client. In response to receiving the encoded token, it is determined that the encoded token is valid. In response to determining that the encoded token is valid, the encoded token is decoded to identify the client identifier and the application credentials. A session with the API is initiated based on the application credentials.

An aspect combinable with any other aspect includes the following features. To initiate the session with the API based on the application credentials, the application credentials are transmitted to an application to which the client makes a call.

An aspect combinable with any other aspect includes the following features. The encoded token is associated with an expiration time. To determine that the encoded token is valid, it is determined that the expiration time has not elapsed.

An aspect combinable with any other aspect includes the following features. To encode the token to include the client identifier and the application credentials, a public key and a private key associated with the token are generated. To decode the encoded token, the public key is used.

An aspect combinable with any other aspect includes the following features. To make a call to the API in response to determining that the request for the token is a validated request, the client is not informed.

An aspect combinable with any other aspect includes the following features. To receive, from the client, the request for the token, it is determined that the client identifier represents a valid client identifier.

An aspect combinable with any other aspect includes the following features. To determine that the client identifier represents the valid client, a hash value of the client identifier included in the request is matched with a stored hash value of a valid client identifier.

Certain aspects of the subject matter described in this disclosure can be implemented as a non-transitory computer-readable medium storing instructions which, when executed by a hardware-based processor, performs operations including the methods described in this disclosure.

Certain aspects of the subject matter described in this disclosure can be implemented as a system that includes one or more processors including a hardware-based processor, and a memory storage including a non-transitory computer-readable medium storing instructions which, when executed by the one or more processors including the hardware-based processor, to perform operations including the methods described in this disclosure.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous.

What is claimed is :

1. A method comprising:
receiving, from a client and by one or more processors, a request for a token to make a call, by the client, to an application programming interface (API), the request comprising a client identifier identifying the client;
in response to receiving the request:
making a call to the API for the token, and
receiving, from the API, the token comprising application credentials; and
in response to receiving the token:
encrypting the client identifier;
encoding the token to include the encrypted client identifier and the application credentials, and
transmitting the encoded token to the client.

2. The method of claim 1, further comprising:
receiving, from the client and by the one or more processors, the encoded token;
in response to receiving the encoded token, determining, by the one or more processors, that the encoded token is valid;
in response to determining that the encoded token is valid, decode the encoded token to identify the client identifier and the application credentials; and
initiating, by the one or more processors, a session with the API based on the application credentials.

3. The method of claim 2, wherein initiating the session with the API based on the application credentials comprises transmitting the application credentials to an application to which the client makes a call.

4. The method of claim 2, wherein the encoded token is associated with an expiration time, wherein determining that the encoded token is valid comprises determining that the expiration time has not elapsed.

5. The method of claim 2, wherein encoding the token to include the client identifier and the application credentials comprises generating a public key and a private key associated with the token, wherein decoding the encoded token comprises utilizing the public key to decode the encoded token.

6. The method of claim 1, wherein, in response to determining that the request for the token is a validated request, making a call to the API for the token comprises making the call without informing the client.

7. The method of claim 1, wherein receiving, from the client, the request for the token, comprises determining that the client identifier represents a valid client identifier.

8. The method of claim 7, wherein determining that the client identifier represents the valid client comprises matching a hash value of the client identifier included in the request with a stored hash value of valid client identifier.

9. A non-transitory computer-readable medium storing instructions which, when executed by a hardware-based processor, perform operations comprising:
receiving, from a client, a request for a token to make a call, by the client, to an application programming interface (API), the request comprising a client identifier identifying the client;
in response to receiving the validated request, determining, using the client identifier, that the request for the token is a validated request,
in response to determining that the request for the token is a validated request:
making a call to the API for the token, and
receiving from the API the token comprising application credentials; and
in response to receiving the token:
encrypting the client identifier;
encoding the token to include the encrypted client identifier and the application credentials, and
transmitting the encoded token to the client.

10. The non-transitory computer-readable medium of claim 9, wherein the operations further comprising:
receiving, from the client, the encoded token;
in response to receiving the encoded token, determining that the encoded token is valid;
in response to determining that the encoded token is valid, decoding the encoded token to identify the client identifier and the application credentials; and
initiating a session with the API based on the application credentials.

11. The non-transitory computer-readable medium of claim 10, wherein initiating the session with the API based on the application credentials comprises transmitting the application credentials to an application to which the client makes a call.

12. The non-transitory computer-readable medium of claim 10, wherein the encoded token is associated with an expiration time, wherein determining that the encoded token is valid comprises determining that the expiration time has not elapsed.

13. The non-transitory computer-readable medium of claim 10, wherein encoding the token to include the encrypted client identifier and the application credentials comprises generating a public key and a private key associated with the token, wherein decoding the encoded token comprises utilizing the public key to decode the encoded token.

14. The non-transitory computer-readable medium of claim 9, wherein, in response to determining that the request for the token is a validated request, making a call to the API for the token comprises making the call without informing the client.

15. The non-transitory computer-readable medium of claim 9, wherein receiving, from the client, the request for the token, comprises determining that the client identifier represents valid client identifier.

16. A system comprising:
one or more processors including a hardware-based processor; and
a computer-readable medium storing instructions which, when executed by the one or more processors, perform operations comprising:
receiving, from a client, a request for a token to make a call, by the client, to an application programming interface (API), the request comprising a client identifier identifying the client;
in response to receiving the validated request, determining, using the client identifier, that the request for the token is a validated request,
in response to determining that the request for the token is a validated request:
making a call to the API for the token, and
receiving, from the API, the token comprising an application credentials; and
in response to receiving the token:
encrypting the client identifier;
encoding the token to include the client identifier and the application credentials, and
transmitting the encoded token to the client.

17. The system of claim 16, wherein the operations further comprising:
receiving, from the client, the encoded token;
in response to receiving the encoded token, determining that the encoded token is valid;
in response to determining that the encoded token is valid, decoding the encoded token to identify the client identifier and the application credentials; and
initiating a session with the API based on the application credentials.

18. The system of claim 17, wherein initiating the session with the API based on the application credentials comprises transmitting the application credentials to an application to which the client makes a call.

19. The system of claim 17, wherein the encoded token is associated with an expiration time, wherein determining that the encoded token is valid comprises determining that the expiration time has not elapsed.

20. The system of claim 17, wherein encoding the token to include the client identifier and the application credentials comprises generating a public key and a private key associated with the token, wherein decoding the encoded token comprises utilizing the public key to decode the encoded token.
